(19) United States
(12) Patent Application Publication
(10) Pub. No.: US 2024/0075973 A1
(43) Pub. Date: Mar. 7, 2024

(54) Stroller with Detachable Auxiliary Power Structure

(71) Applicant: New Century Products Co., Ltd., Taipei City (TW)

(72) Inventor: Fu-Tsun LIN, Taipei City (TW)

(21) Appl. No.: 17/956,811

(22) Filed: Sep. 29, 2022

(30) Foreign Application Priority Data
Sep. 5, 2022 (TW) 111209628

(51) Int. Cl. B62B 5/00; B62B 7/06

(52) U.S. Cl. CPC B62B 5/0036; B62B 7/06

(57) ABSTRACT

The present invention provides a stroller with a detachable auxiliary power structure including a stroller, at least one power control module and a cell unit. The stroller includes a front wheel member, a rear wheel member, a right folding frame and a left folding frame, the front ends of the right folding frame and the left folding frame are pivotally connected to the front wheel member, and the rear ends of the right folding frame and the left folding frame are pivotally connected to the rear wheel member. At least one power control module is placed on the bottom of the rear wheel frame and includes: a drive motor outputting a rotational speed and a torque, a gear box and a power output shaft connected with the gear box and the rear right wheel or the rear left wheel. A battery unit is connected to the drive motor.

### (a) TECHNICAL FIELD OF THE INVENTION

The present invention relates to a stroller, and more particularly to a stroller with a detachable auxiliary power structure.

### (b) DESCRIPTION OF THE PRIOR ART

Families with infants and young children will usually have a stroller for infants and young children to sit and lie down, so that adults can reduce the burden of holding or carrying, and infants and young children can sit or lie in the stroller safely and comfortably at the same time. At present, there are many types of baby strollers on the market. With regard to frame structure, there are various folding types for consumers to choose from; with regard to equipment, the lightest baby stroller only has a seat, and the more luxurious baby strollers are equipped with a handrail, sunshade covers, dinner plates or baskets, etc. However, the disadvantage of the above-mentioned strollers is that these strollers do not have power, and they must be pushed and pulled by manpower to make the strollers move forward or backward.

Furthermore, a baby stroller that is pushed by manpower will cause a physical burden on the parents when the baby stroller is pushed up a slope or a long-distance push. Therefore, an electric-driven baby stroller is launched on the market, which can be driven by a motor and manually adjust the speed of the baby stroller through buttons.

In order to solve the problems mentioned above, the inventor has invested in a lot of research, development, and effort in making breakthroughs and innovations, hoping to solve the current shortcomings with novel technical methods, not only bringing better products to the society, but also promoting industrial development at the same time.

### SUMMARY OF THE INVENTION

In view of the aforementioned problems, the main purpose of the present invention is to provide a stroller with a detachable auxiliary power structure including a power control module, a battery unit and a stroller; wherein the power control module includes a driving motor, a deceleration mechanism and a power output shaft. The stroller of the present invention can achieve humanist control and optimal safe use by adjusting the driving motor and the deceleration mechanism. In addition, the stroller with the detachable auxiliary power structure can be used for a plurality of infants, children or pets, so that the stroller can be used in many aspects.

To achieve the above objective, the present invention provides a stroller with a detachable auxiliary power structure comprising a stroller, at least one power control module and a battery unit; wherein the stroller includes a front wheel member, a rear wheel member and a folding member. The front wheel member includes a front wheel frame, a front right wheel and a front left wheel installed on the bottom of the front wheel frame. The rear wheel member includes a rear wheel frame, a rear right wheel and a rear left wheel installed on the bottom of the rear wheel frame; wherein a handrail is coupling to the rear wheel frame, and the handrail extends toward the rear side of the rear wheel frame. The folding member includes a right folding frame and a left folding frame; the front ends of the right folding frame and the left folding frame are pivotally connected to the front wheel member; and the rear ends of the right folding frame and the left folding frame are pivotally connected to the rear wheel member. Furthermore, at least one power control module is placed on the bottom of the rear wheel frame, and at least one power control module includes a drive motor, a deceleration mechanism, a drive controller and two drum brakes; wherein the drive motor can output a rotational speed and a torque; the deceleration mechanism is connected with the drive motor, and the rotational speed and the torque of the drive motor are changed through the deceleration mechanism; the drive controller is connected with the drive motor, and the two drum brakes are respectively fixed on the tire of the rear right wheel and the tire of the rear left wheel, and the two drum brakes rotating at the same speed as the tires; wherein each drum brake is composed of a brake drum and a brake shoe, when braking, the circular brake shoes open outward and rub against the inner surface of the brake drum that rotates with the tire, forcing the brake drum and tire to slow down until brake drum and tire stop rotating. Furthermore, the battery unit is connected to the drive motor as a power source.

In some embodiments, the stroller further includes a power output shaft, one end of the power output shaft is connected with a gear box, and another end is connected with the rear right wheel or the rear left wheel, and the power output shaft is driven to rotate through the gear box, and enabling operation of the rear right wheel or rear left wheel.

In some embodiments, the stroller further includes a differential, and the differential connected with the power output shaft and the gear box is used for controlling an output speed of the drive motor.

In some embodiments, each folding frame includes an upper front cross rod, a lower front cross rod, an upper rear cross rod, a lower rear cross rod and a support frame; and the support frame includes an upper folding frame member, a lower folding frame member and a central vertical rod connected between the upper folding frame member and the lower folding frame member. The rear end of the upper front cross rod and the front end of the upper rear cross rod are pivotally connected to both ends of the upper folding frame member, and the rear end of the lower front cross rod and the front end of the lower rear cross rod are pivotally connected to both ends of the lower folding frame member. The front ends of the upper front cross rod and the lower front cross rod are respectively pivotally connected to the front wheel frame, and the rear ends of the upper rear cross rod and the lower rear cross rod are respectively pivoted to the rear wheel frame. A front connecting rod is disposed between both sides of the lower front cross rod, and a rear connecting rod is disposed between both sides of the lower rear cross rod.

In some embodiments, a base is disposed on a handrail, and the base includes at least a start button, a left turn button, a right turn button and a control module; wherein at least a start button is disposed on a front side of the base, the left turn button and the right turn button are disposed on opposite sides of at least one start button, and the control module is disposed above the base. Furthermore, a circuit board is embedded in the base, and the circuit board is electrically connected with the drive controller and the battery unit. Moreover, the control module has a power button, a slow start acceleration button, a slow deceleration button and a reversing button; wherein the slow start acceleration button, the slow deceleration button and the reversing button can control the drive motor to drive the stroller to move forward, back or turn; and the control module is a touch screen or a display screen.

In some embodiments, the stroller further includes a plurality of sensing elements disposed on the rear wheel member, and the plurality of sensing elements are electrically connected with the drive controller and the battery unit; wherein the plurality of sensing elements include a weight sensing element, a temperature sensing element, a velocity sensing element and an inertial measurement unit.

In some embodiments, at least one power control module includes a left power control module and a right power control module. The left power control module includes a left drive motor, a left deceleration mechanism and a left drive controller. One end of the left driver motor is connected with the left deceleration mechanism, another end of the left drive motor is connected with the drive controller, and the left deceleration mechanism is used to drive the rear left wheel. The right power control module includes a right driver motor, a right deceleration mechanism and a right drive controller. One end of the right driver motor is connected with the right deceleration mechanism, another end of the right drive motor is connected with the drive controller, and the right deceleration mechanism is used to drive the rear right wheel.

In some embodiments, at least one power control module further includes two universal joints, the two universal joints are connected with two support frames, the two support frames are respectively fixed on the rear right wheel and the rear left wheel, the two universal joints is connected with the rear wheel frame.

In some embodiments, the rear right wheel has a right inner frame, a right outer frame and a right outer tire structure, the rear left wheel has a left inner frame, a left outer frame and a left outer tire structure; wherein the right outer tire structure is combined on the right outer frame, and the left outer tire structure is combined on the left outer frame; the right outer tire structure and the left outer tire structure are composed of at least one tire unit, and at least one tire unit can be movably disassembled from the right outer frame or the left outer casing frame.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

The above and other objects, features, and other advantages of the present invention will be more clearly understood from the following detailed description taken in conjunction with the accompanying drawings, in which:

FIG. 1 is a schematic view of a stroller with a detachable auxiliary power structure of the present invention;

FIG. 2 is a schematic view of a power control module according to the first embodiment of the present invention;

FIG. 3 is a schematic view of a handrail of the present invention;

FIG. 4 is a schematic view of the power control module according to the second embodiment of the present invention; and

FIG. 5 is a schematic view of the power control module according to the third embodiment of the present invention.

### DETAILED DESCRIPTION OF THE PREFERRED EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

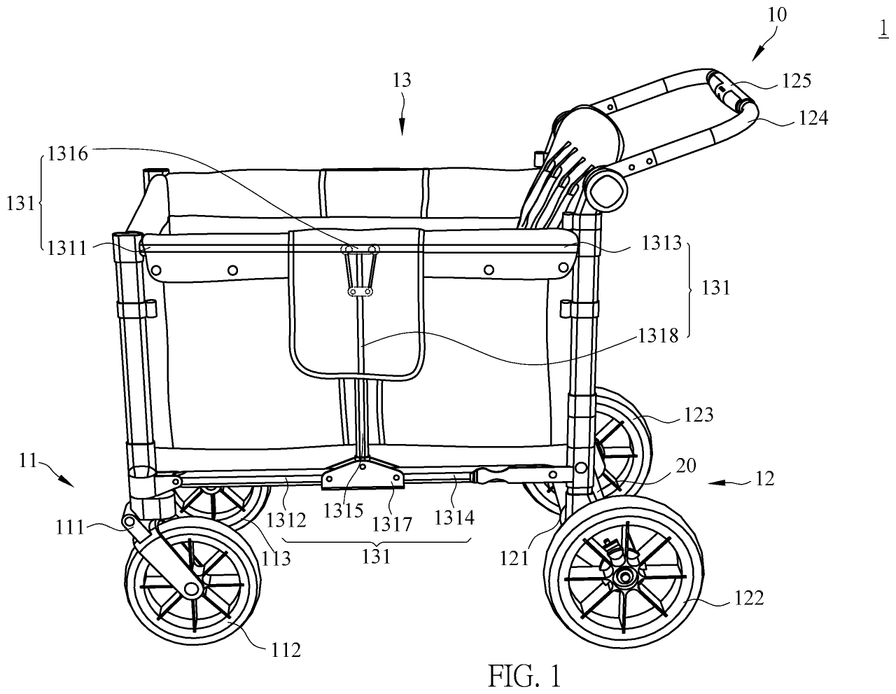

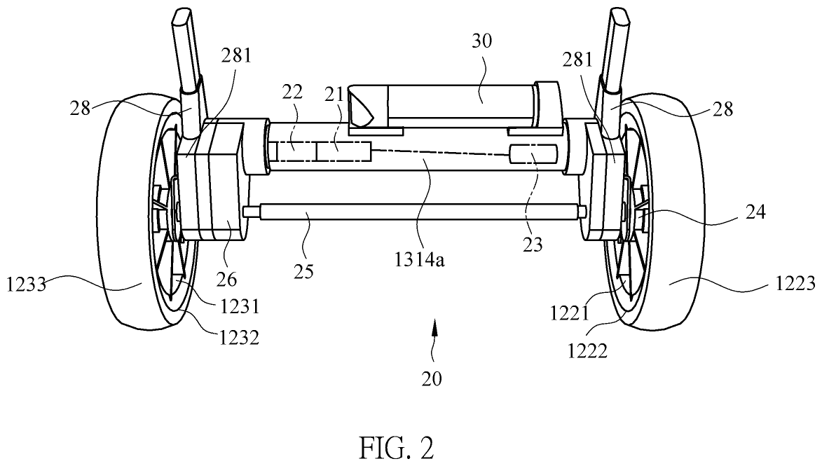

Please refer to FIG. 1 and FIG. 2, FIG. 1 is a schematic view of a stroller with a detachable auxiliary power structure of the present invention; and FIG. 2 is a schematic view of a power control module according to the first embodiment of the present invention.

As shown in FIG. 1 and FIG. 2, the present invention provides a stroller with a detachable auxiliary power structure 1 including a stroller 10, at least one power control module 20 and a battery unit 30; wherein the stroller 10 includes a front wheel member 11, a rear wheel member 12 and a folding member 13. The front wheel member 11 includes a front wheel frame 111, a front right wheel 112 and a front left wheel 113 installed on the bottom of the front wheel frame 111. The rear wheel member 12 includes a rear wheel frame 121, a rear right wheel 122 and a rear left wheel 123 installed on the bottom of the rear wheel frame 121; wherein a handrail 124 is coupled to the rear wheel frame 121, and the handrail 124 extends toward the rear side of the rear wheel frame 121. Moreover, the folding member 13 includes a right folding frame 131 and a left folding frame (not shown in figure), the front ends of the right folding frame 131 and the left folding frame are pivotally connected to the front wheel member 11, and the rear ends of the right folding frame 131 and the left folding frame are pivotally connected to the rear wheel member 12. Furthermore, each folding frame includes an upper front cross rod 1311, a lower front cross rod 1312, an upper rear cross rod 1313, a lower rear cross rod 1314 and a support frame 1315; and the support frame 1315 includes an upper folding frame member 1316, a lower folding frame member 1317 and a central vertical rod 1318 connected between the upper folding frame member 1316 and the lower folding frame member 1317. The rear end of the upper front cross rod 1311 and the front end of the upper rear cross rod 1313 are pivotally connected to both ends of the upper folding frame member 1316, and the rear end of the lower front cross rod 1312 and the front end of the lower rear cross rod 1314 are pivotally connected to both ends of the lower folding frame member 1317. The front ends of the upper front cross rod 1311 and the lower front cross rod 1312 are respectively pivotally connected to the front wheel frame 111, and the rear ends of the upper rear cross rod 1313 and the lower rear cross rod 1314 are respectively pivoted to the rear wheel frame 121. In addition, a front connecting rod (not shown in figure) is disposed between both sides of the lower front cross rod 1312, and a rear connecting rod 1314a is disposed between both sides of the lower rear cross rod 1314. As shown in FIG. 1 and FIG. 2, at least one power control module 20 is disposed at the bottom of the rear wheel frame 121, and at least one power control module 20 includes a drive motor 21, a deceleration mechanism 22, a drive controller 23, two drum brakes 24, a power output shaft 25, a gear box 26 and a battery unit 30; wherein the drive motor 21 can output a rotational speed and a torque; the deceleration mechanism 22 is connected with the drive motor 21, and the rotational speed and the torque of the drive motor 21 are changed through the deceleration mechanism 22. Furthermore, the drive controller 23 is connected with the drive motor 21; wherein an installation position of the drive motor 21 may be randomly varied based on the user's requirements. The driving motor 21 can be placed on the rear right wheel 122 and the rear left wheel 123 respectively, or the driving motor 21 can be placed on the rear connecting rod 1314a or placed in the rear connecting rod 1314a, but the present invention is not limited thereto. Furthermore, a type of the driving motor 21 may be randomly varied based on the user's requirements, and the driving motor 21 may be a hub motor, a brushed DC motor or a tubular motor, but the present invention is not limited thereto, any currently available motors are included in the present invention. The two drum brakes 24 are respectively fixed on the tire of the rear right wheel 122 and the tire of the rear left wheel 123, and the two drum brakes 24 rotate at the same speed as the tires. Each drum brake 24 is composed of a brake drum and a brake shoe. When braking, the circular brake shoes open outward and rub against the inner surface of the brake drum that rotates with the tire, forcing the brake drum and tire to slow down until brake drum and tire stop rotating. Moreover, one end of the power output shaft 25 is connected with a gear box 26, another end is connected with the rear right wheel 122 or the rear left wheel 123; and the power output shaft 25 is driven to rotate through the gear box 26, so that an operation of the rear right wheel 122 or rear left wheel 123 can be performed. In addition, the battery unit 30 as a power source is connected with the drive controller 23; wherein the driving motor 21 is a 250 W DC brushless motor, the decelerating mechanism 22 is a 45 reduction ratio mechanism, and the rotational speed is about 3.2 Km/Hr. Furthermore, at least one power control module 20 further includes two universal joints 28, and the two universal joints 28 are connected with two support frames 281; wherein the two support frames 281 are respectively fixed on the rear right wheel 122 and the rear left wheel 123; the two universal joints 28 are connected with the rear wheel frame 121; and the two universal joints 28 can be connected with various types of strollers.

Further, the rear right wheel 122 has a right inner frame 1221, a right outer frame 1222 and a right outer tire structure 1223; and the rear left wheel 123 has a left inner frame 1231, a left outer frame 1232 and a left outer tire structure 1233. The right outer tire structure 1223 is combined with the right outer frame 1222, and the left outer tire structure 1233 is combined with the left outer frame 1232. Furthermore, the right outer tire structure 1223 and the left outer tire structure 1233 are composed of at least one tire unit; and at least one tire unit can be movably removed from the right outer frame 1222 or the left outer frame 1232. The material, tread pattern and structure of at least one tire unit may be randomly varied based on the user's requirements, and various types of tires can be replaced according to various terrains, but the present invention is not limited thereto.

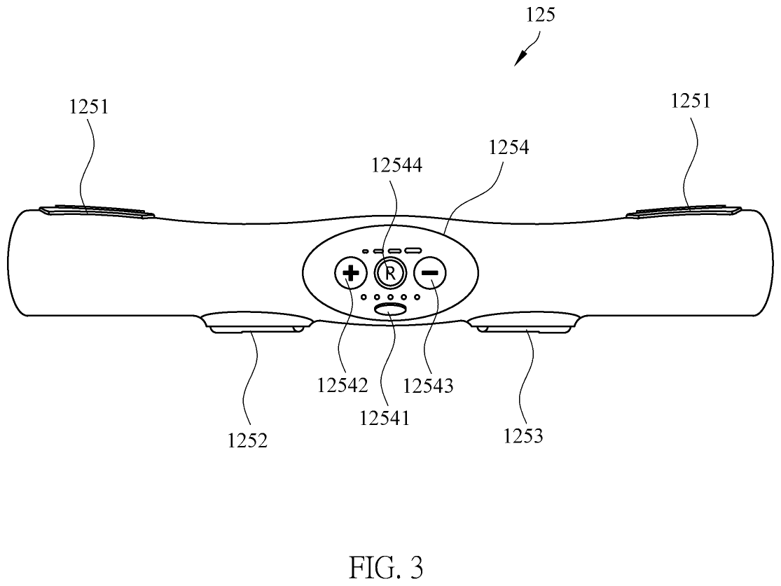

As shown in FIG. 2 and FIG. 3, the handrail 124 includes a base 125, and the base 125 includes at least a start button 1251, a left turn button 1252, a right turn button 1253 and a control module 1254; wherein at least a start button 1251 is disposed on a front side of the base 125, the left turn button 1252 and the right turn button 1253 are disposed on opposite sides of at least one start button 1251, and the control module 1254 is disposed above the base 125. Furthermore, a circuit board is embedded in the base 125, and the circuit board is electrically connected with the drive controller 23 and the battery unit 30. Moreover, the control module 1254 has a power button 12541, a slow start acceleration button 12542, a slow speed reduction button 12543 and a reversing button 12544; wherein the slow start acceleration button 12542, the slow deceleration button 12543 and a reversing button 12544 can control the drive motor 21 to drive the stroller to move forward, back or turn; and the control module 1252 is a touch screen or a display screen. In addition, the styles or positions of all above mentioned buttons may be randomly varied based on the user's requirements, and the drawings are only for illustration, but the present invention is not limited thereto.

As shown in FIG. 2 and FIG. 3, the stroller 1 further includes a plurality of sensing elements disposed on the rear wheel member 12, and the plurality of sensing elements are electrically connected with the control module 1254 and the battery unit 30; wherein the plurality of sensing elements include a weight sensing element 31, a velocity sensing element 32, an inertial measurement unit 33 and a temperature sensing element 34; wherein the weight sensing element 31 is disposed on the rear wheel frame 121, and weight sensing element 31 may be a leveling instrument or a gyroscope to obtain a load value 12545 of the stroller 1, and transmit the load value 12545 to the control module 1254. Furthermore, the velocity sensing element 32 disposed on the rear right wheel 122 and the rear left wheel 123 can obtain a wheel speed value 12456 of the rear right wheel 122 and the rear left wheel 123, and transmit the wheel speed value to the control module 1254; wherein the wheel speed value 12456 can be divided into 4 statuses. Moreover, the inertial measurement unit 33 disposed on the rear wheel frame 121 is composed of a three-axis gyroscope and a three-direction accelerometer to obtain an angle of inclination displayed to the control module 1254 as an uphill mode 12547 or a downhill mode 12548. In addition, the temperature sensing element 34 disposed on the rear wheel frame 121 is used to detect a temperature of the drive motor, and then compare with a preset value to determine whether to generate a warning signal or not, and send the warning signal to the control module 1254 showing the warning signal.

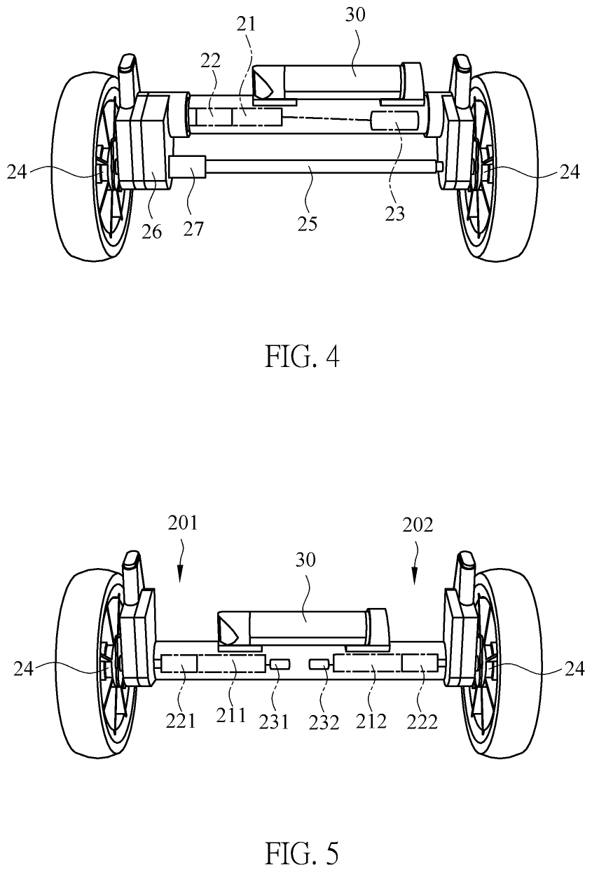

Please refer to FIG. 4, FIG. 4 is a schematic view of the power control module according to the second embodiment of the present invention.

As shown in FIG. 4, the stroller 1 further includes a differential 27, and the differential 27 connected with the drive motor 21 and the power output shaft 25 is used for controlling a output speed of the drive motor 21; wherein the drive motor 21 is a DC brushless motor, the deceleration mechanism 22 is a 45 reduction ratio mechanism, and the power control module 20 can be used as an auxiliary power kit for the stroller 1 of the detachable auxiliary power structure.

Please refer to FIG. 5, FIG. 5 is a schematic view of the power control module according to the third embodiment of the present invention.

As shown in FIG. 5, the stroller 1 includes a left power control module 201 and a right power control module 202. The left power control module 201 includes a left drive motor 211, a left deceleration mechanism 221 and a left drive controller 231. One end of the left driver motor 211 is connected with the left deceleration mechanism 221, another end of the left drive motor 211 is connected with the drive controller 231, and the left deceleration mechanism 221 is used to drive the rear left wheel 123. The right power control module 202 includes a right driver motor 212, a right deceleration mechanism 222 and a right drive controller 232. One end of the right driver motor 212 is connected with the right deceleration mechanism 222, another end of the right drive motor 212 is connected with the drive controller 232, and the right deceleration mechanism 222 is used to drive the rear right wheel 122. The left driver motor 211 and the right driver motor 212 are DC brushless motors; the left reduction mechanism 221 and the right reduction mechanism 222 are 60 reduction ratio mechanisms; and the left power control module 201 and the right power control module 202 can be used as an auxiliary power kit for the stroller 1 of the detachable auxiliary power structure.

The stroller with the detachable auxiliary power structure of the present invention will automatically detect and change to the best operating mode in various driving conditions. For example, when the stroller drives on flat ground, the rotation direction and intensity of the stroller can be detected and the driving speed can be adjusted automatically; and when the stroller drives uphill, it can detect the gradient and automatically switch to “uphill mode”, which can easily climb up the slope with the assistance of the drive motor. Furthermore, when the stroller drives downhill, it can detect the gradient and automatically switch to “downhill mode” and use automatic braking, which can make the stroller travel slowly and safely. Moreover, when the stroller drives on a slope, it can detect the inclination angle and automatically switch to the “one-side anti-flow mode”, which can support the stroller to travel, so that the stroller can go straight.

The foregoing description, for the purpose of explanation, has been described with reference to specific embodiments; however, the embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the disclosure to the precise forms disclosed. Modifications and variations are possible in view of the above demonstrations.

1. A stroller with a detachable auxiliary power structure, including:
a stroller including:
a front wheel member including a front wheel frame, a front right wheel and a front left wheel installed on a bottom of the front wheel frame;
a rear wheel member including a rear wheel frame, a rear right wheel and a rear left wheel installed on the bottom of the rear wheel frame; wherein a handrail is coupled to the rear wheel frame, and the handrail extends toward the rear side of the rear wheel frame; and
a folding member including a right folding frame and a left folding frame, the front ends of the right folding frame and the left folding frame are pivotally connected to the front wheel member, and the rear ends of the right folding frame and the left folding frame are pivotally connected to the rear wheel member;
at least one power control module placed on the bottom of the rear wheel frame and including:
a drive motor outputting a rotational speed and a torque;
a deceleration mechanism connected with the drive motor, and the rotational speed and the torque of the drive motor changed through the deceleration mechanism;
a drive controller connected with the drive motor; and
two drum brakes respectively fixed on the tire of the rear right wheel and the tire of the rear left wheel, and the two drum brakes rotating at the same speed as the tires; wherein each drum brake is composed of a brake drum and a brake shoe, when braking, the circular brake shoes open outward and rub against the inner surface of the brake drum that rotates with the tire, forcing the brake drum and tire to slow down until brake drum and tire stop rotating; and
a battery unit connected to the drive motor as a power source,
wherein at least one power control module further includes two universal coupling members respectively connected with two support frames; the two support frames are respectively fixed on the rear right wheel and the rear left wheel; and the two universal coupling members are detachably connectable with the rear wheel frame.

2. The stroller with the detachable auxiliary power structure according to claim 1, further including a power output shaft, wherein one end of the power output shaft is connected with a gear box, another end is connected with the rear right wheel or the rear left wheel, the power output shaft is driven to rotate through the gear box, and enabling operation of the rear right wheel or rear left wheel.

3. The stroller with the detachable auxiliary power structure according to claim 2, further including a differential; wherein the differential is connected with the power output shaft and gear box, and the differential is used for controlling an output speed of the drive motor.

4. The stroller with the detachable auxiliary power structure according to claim 1, wherein each folding frame includes an upper front cross rod, a lower front cross rod, an upper rear cross rod, a lower rear cross rod and a support frame; the support frame includes an upper folding frame member, a lower folding frame member and a central vertical rod connected between the upper folding frame member and the lower folding frame member; the rear end of the upper front cross rod and the front end of the upper rear cross rod are pivotally connected to both ends of the upper folding frame member; the rear end of the lower front cross rod and the front end of the lower rear cross rod are pivotally connected to both ends of the lower folding frame member; the front ends of the upper front cross rod and the lower front cross rod are respectively pivotally connected to the front wheel frame; the rear ends of the upper rear cross rod and the lower rear cross rod are respectively pivoted to the rear wheel frame; a front connecting rod is disposed between both sides of the lower front cross rod, and a rear connecting rod is disposed between both sides of the lower rear cross rod.

5. The stroller with the detachable auxiliary power structure according to claim 1, wherein a base is disposed on a handrail, and the base includes at least a start button, a left turn button, a right turn button and a control module; the at least a start button is disposed on a front side of the base, the left turn button and the right turn button are disposed on opposite sides of at least one start button, and the control module is disposed above the base; a circuit board is embedded in the base, and the circuit board is electrically connected with the drive controller and the battery unit.

6. The stroller with the detachable auxiliary power structure according to claim 5, wherein the control module has a power button, a slow start acceleration button, a slow deceleration button and a reversing button; and the left turn button, the right turn button, the slow start acceleration button, the slow deceleration button and the reversing button can control the drive motor to drive the stroller to move forward, back or turn.

7. The stroller with the detachable auxiliary power structure according to claim 1, further including a plurality of sensing elements disposed on the rear wheel member, and the plurality of sensing elements are electrically connected with the drive controller and the battery unit; wherein the plurality of sensing elements include a weight sensing element, a temperature sensing element, a velocity sensing element and an inertial measurement unit.

8. The stroller with the detachable auxiliary power structure according to claim 1, wherein at least one power control module includes a left power control module and a right power control module; the left power control module includes a left drive motor, a left deceleration mechanism and a left drive controller; one end of the left driver motor is connected with the left deceleration mechanism, another end of the left drive motor is connected with the drive controller, and the left deceleration mechanism is used to drive the rear left wheel; the right power control module includes a right driver motor, a right deceleration mechanism and a right drive controller, one end of the right driver motor is connected with the right deceleration mechanism, another end of the right drive motor is connected with the drive controller, and the right deceleration mechanism is used to drive the rear right wheel.

9. (canceled)

10. The stroller with the detachable auxiliary power structure according to claim 1, wherein the rear right wheel has a right inner frame, a right outer frame and a right outer tire structure, the rear left wheel has a left inner frame, a left outer frame and a left outer tire structure; the right outer tire structure is combined on the right outer frame, the left outer tire structure is combined on the left outer frame; the right outer tire structure and the left outer tire structure are composed of at least one tire unit, and at least one tire unit can be movably disassembled from the right outer frame or the left outer casing frame.
